(19) United States
(12) Patent Application Publication
(10) Pub. No.: US 2005/0256746 A1
(43) Pub. Date: Nov. 17, 2005

(54) System for managing recorded audio medical information

(76) Inventor: John R. Zaleski, West Brandywine, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/068,588

(22) Filed: Feb. 28, 2005

Related U.S. Application Data
(60) Provisional application No. 60/571,326, filed on May 14, 2004.

(51) Int. Cl. G06F 17/60

(52) U.S. Cl. 705/3

(57) ABSTRACT

An automated system automatically provides a linkage (e.g., using a hyperlink) between an audio recording (specifically, metadata associated with the audio recording) and a patient electronic medical record. A system manages recorded audio information concerning a patient medical condition. An interface receives a signal comprising recorded dictated audio information concerning a patient medical condition and including dictated patient identification information. A voice recognition processor automatically processes the signal by parsing data representing the audio information in the signal and identifying a patient identifier in the parsed data. A database manager compares the identified patient identifier with a plurality of patient identifiers derived from a repository to identify one or more matching patient identifiers associated with records stored in the repository.

This is a non-provisional application of provisional application Ser. No. 60/571,326 by J. R. Zaleski filed May 14, 2004.

### FIELD OF THE INVENTION

This invention concerns an automated system and user interface for managing healthcare audio files so they may be readily accessed and processed without requiring manual intervention

### BACKGROUND INFORMATION

In a hospital, a physician typically dictates a report such as for a patient examination which is stored on an audio cassette, for example. This dictated report is then subsequently located and transcribed by a transcriptionist. The transcribed report is filed usually by be being appended to a medical record of the patient concerned. These steps are prone to manual error, delay and inconsistency and depend on the skills and training of the workers involved. In existing systems once an audio dictation (say, from Radiology) is created for a patient, a unit clinician (nurse, physician) needs to search for the audio recording, perhaps using an in-house telephone system, or via an audio archive, for example. The search for an audio recording as well as the identification, transcription, processing and filing of an audio recording is a burdensome, error prone manual process. A system according to invention principles addresses these deficiencies and related problems.

### SUMMARY OF THE INVENTION

An automated system automatically provides a linkage between an audio recording and its associated metadata (such as a patient identifier, medical record number, patient specific identification information and links to patient files) to associate audio dictation files with existing electronic medical records enabling ready access to patient specific audio information. A system manages recorded audio information concerning a patient medical condition. An interface receives a signal comprising recorded dictated audio information concerning a patient medical condition and including dictated patient identification information. A voice recognition processor automatically processes the signal by parsing data representing the audio information in the signal and identifying a patient identifier in the parsed data. A database manager compares the identified patient identifier with a plurality of patient identifiers derived from a repository to identify one or more matching patient identifiers associated with records stored in the repository.

### BRIEF DESCRIPTION OF THE DRAWING

FIG. 1 shows a healthcare system for processing audio data, according to invention principles.

FIG. 2 shows a flowchart of a process employed by the system of FIG. 1 for processing audio data, according to invention principles.

### DETAILED DESCRIPTION OF INVENTION

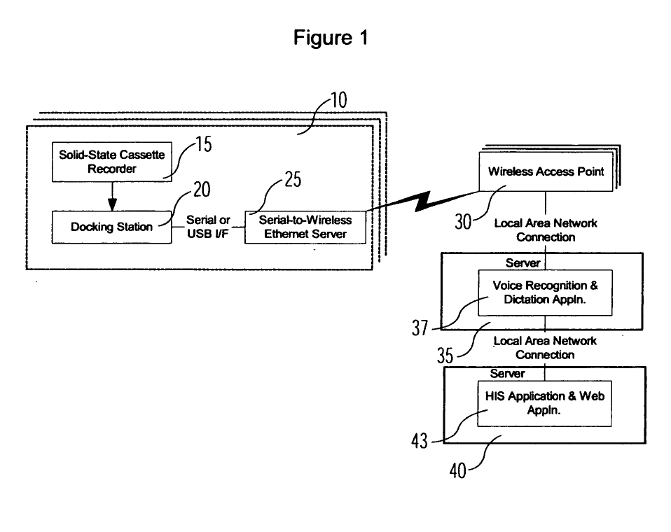

FIG. 1 shows a healthcare system for processing audio data. The system automatically associates audio dictation files with existing electronic medical records so that the audio files may be rapidly retrieved. The system advantageously eliminates the need for manual association of an audio file of a patient with a medical record of a particular patient by a transcriptionist or nursing staff. The system provides a user interface and a database manager that automatically associates an audio recording with a particular patient. The system automatically provides a link (e.g., a hyperlink such as a URL (Universal Resource Locator)) between an audio recording file and associated patient metadata such as a patient identifier, medical record number (MRN), patient specific identification information and links (e.g., hyperlinks) to files associated with a specific patient.

A database management system associates an audio recording of a clinician with patient metadata to establish a one-to-one mapping between a specific patient and an audio recording whereby an authorized clinician can promptly review the recording simply by clicking on an audio file hyperlink in an electronic medical record, for example. The System also provides a storage archive whereby the recordings are maintained (outside of a clinical information system of a HIS (Hospital Information System)) so that local storage requirements are not burdened. Existing systems do not provide a way to establish a virtual linkage between an audio recording and a patient electronic medical record. The system created link comprises a virtual linkage (hyperlink) that associates a patient specific medical record number, for example, in patient metadata with a particular transcribed audio recording and an actual recorded dictation.

An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. A database manager comprises a database management application for storing, processing, structuring and retrieving data from one or more databases or repositories. The database manager also supports querying of database information. An interface is any one or combination of, hardware, firmware, and/or software for receiving and communicating data representing a signal comprising recorded dictated audio information concerning a patient medical condition and other data. A voice recognition processor processes data representing a voice or audio signal by parsing, analyzing and filtering data representing audio information to provide data indicating or representing particular content of the voice or audio signal.

FIG. 1 shows a healthcare system for processing audio data. A physician conducting a patient examination dictates examination notes that are recorded using solid-state portable digital audio recorder 15 in unit 10. Portable digital audio recorder 15 is subsequently inserted in docking station 20. Data representing recorded audio information is automatically downloaded from portable digital audio recorder 15 to docking station 20 for storage within docking station 20. Docking station 20 provides connectivity via serial or USB connection to a serial-to-Ethernet wireless application operating on server 25. The recorded audio information acquired by docking station 20 is communicated by USB (Universal Serial Bus) link or other serial link to server 25. Server 25 executes the executable application that converts the received audio data from serial to Ethernet compatible protocol and automatically wirelessly communicates the Ethernet data to wireless access point 30. Access point 30 provides a Local Area Network (LAN) connection to server 35. Server 35 executes executable application 37 that receives data representing the recorded audio information in Ethernet compatible protocol and processes and interprets the audio information using a voice recognition processor.

The voice recognition processor automatically extracts raw audio signal data from processed received Ethernet data and retrieves the patient-specific and patient identifying information from the raw audio signal. For this purpose the voice recognition processor automatically processes the received recorded audio information by parsing data representing the audio information to identify a patient identifier in the parsed data. Executable application 37 searches for patient identifiable information within audio recordings such as a patient name as recorded by a physician and creates audio files in a desired audio format (such as .WAV compatible format), for example. Application 37 generates a patient metadata vector containing ASCII character text information comprising patient name, patient identifier, patient medical record number (MRN), patient specific identification information and other patient specific information derived from the received recorded audio information.

Application 37 extracts a patient identifier (such as a patient name or other patient specific code identifier) using voice recognition software (such as a commercial product exemplified by a Naturally Speaking™ application by Dragons™ software, for example). The recognition software produces a text log or transaction record of the recording, including a phonetic translation of the recording of a patient name and other identifiers, for example. The application 37 voice recognition processor searches the log and associates a name of a patient as a key identifier (and a medical record number and other patient specific information, if recorded). The audio information (e.g., .WAV compatible) data files and derived patient identification information are communicated by application 37 via a Local Area Network connection to a Healthcare Information System (HIS) and Internet compatible application 43 operating on server 40. The audio information data files are stored and managed using a database management system within HIS application 43 operating on server 40.

HIS application 43 links (associates) received patient identification information (derived by the voice recognition processor of application 37) with matching corresponding stored metadata of a selected particular patient. For this purpose HIS application 43 selects matching patient identification information of a particular patient from metadata information of multiple different patients. This selection is achieved by HIS application 43 performing text and character matching involving comparing one or more of, patient name, patient identifier, patient medical record number and other patient specific information to identify matching patient metadata of a particular patient from the metadata of the multiple different patients. Application 43 automatically downloads the recorded dictated audio information derived from voice recorder 15 and stores the recorded dictated audio information in a .WAV compatible file format, for example, in a patient medical record of the particular patient identified using the selected matching patient identification information. Thereby the recorded dictated audio information in WAV compatible file format is stored within a patient specific location in a repository and is accessible in response to user selection of a system created hyperlink in a retrieved patient medical record.

HIS application 43 employs probabilistic patient identifier matching in the event a direct single match with metadata of a particular patient is not made. A direct single match with metadata of a particular patient may not be made because of poor phonetic condition of a recording and subsequent impaired voice recognition and translation of a recording to text. Application 43 employs the probabilistic patient identifier matching to automatically associate the patient identification information received from application 37 with metadata of a single particular patient. A match is declared if a determined match probability for a single particular patient exceeds a predetermined threshold. If the HIS application probability matching function does not find a single match meeting the predetermined threshold, or a match that substantially exceeds in probability other identified matches, HIS application 43 generates a message for communication to a user or presentation to a user on a displayed image. The displayed image indicates the degree of match found between the patient identification information received from application 37 and metadata concerning one or more patients accessed by HIS application 43. The displayed image also enables the user to optionally link (associate) metadata of a selected one of the one or more particular patients with the patient identification information received from application 37. Thereby, for example, a nurse is presented with a list of the metadata associated with multiple different patients and is able to establish a virtual linkage between an audio file and a specific patient. This linkage enables audio files of a particular patient to be retrieved by activating the created link. The created link (e.g., a hyperlink) associates an audio file of a particular patient with a corresponding Electronic Patient Record (EPR) of the particular patient and allows a clinician to be able listen to the audio file (or view a transcribed audio file) at will by clicking the hyperlink associated with the metadata of the particular patient corresponding to this audio file.

A healthcare user is presented with a displayed image option enabling the user to validate an automatic (or manual) assignment of received recorded audio information to a specific patient identifier (e.g., a patient medical record number). As an example, if application 43 determines more than one patient identifier, e.g., of “John Smith” is found that may be assigned to received recorded audio information, a user is able to perform a tie-break and associate a single particular identifier with received recorded audio information. A user is thereby able to manually associate “John Smith 1” (and a specific medical record number) with received recorded audio information in preference to “John Smith 2”, for example. The assignment creates a link (e.g., a hyperlink) enabling access of received recorded audio information from an EPR and also creates data representing a primary key within a patient record structured database that is used to associate that recording with the patient.

Application 43 compares patient identification information, derived by application 37 from received recorded audio information, with patient identification information of an existing database (or multiple existing databases) of patient records accessed by a database management application within application 43 from an associated database. In response to determination of a match, a web browser compatible user interface provided by application 43 displays audio recordings concerning a population of patients associated with a user interface display image currently being viewed by a user. The user interface display image currently being viewed by the user, following user navigation within a Clinical Information System application, may indicate a patient census (a list of patients) of a healthcare worker such as a physician or nurse. The patient census is derived from a database via the database management application within HIS application 43. A user is able to manually create a (virtual) linkage mapping. This linkage mapping is recorded and a hyperlink is created within an electronic patient medical record for the patient that associates this recording with a particular patient, as illustrated in the sample list below.

| Patient name | Association |
|---|---|
| John Smith | 400432 □ |
| John L. Smith | 400498 □ |
| John P. Smith | 400504 □ |
| John T. Smith | 400982 □ |

A user, by selecting a checkbox, establishes this virtual link between an audio recording and the selected patient. The user action automatically creates this linkage for accessing the audio recording within the electronic medical record for this patient. In an alternative embodiment, the HIS application 43 probabilistic patient identifier matching function automatically creates this linkage for this patient in response to a determination that the probability of match exceeds a predetermined threshold and exceeds match probability of other candidates by a predetermined margin. In the event that duplicate or replicated names or identifiers do not exist for a specific patient, the audio recording is automatically associated without causing the user to perform the virtual linkage process above or invoking the probabilistic matching function. The system is particularly useful for in-hospital recording of information or maintaining dictation in general practices but also has general applicability in non-healthcare fields.

Application 43 further provides a web browser based user interface enabling audio reproduction of raw audio file data or display of transcribed audio files accessed using links created by application 43 from within a patient medical record, for example. A clinician (e.g., a nurse) accesses any of the available raw audio files or transcribed audio files associated with a particular patient of specified name or medical record number. In other embodiments applications 37 and 43 (and other applications used in the system of FIG. 1) may be located on server 35 or 40 or may reside on one or more processing devices located on the FIG. 1 LAN and may be a single application or multiple distributed applications.

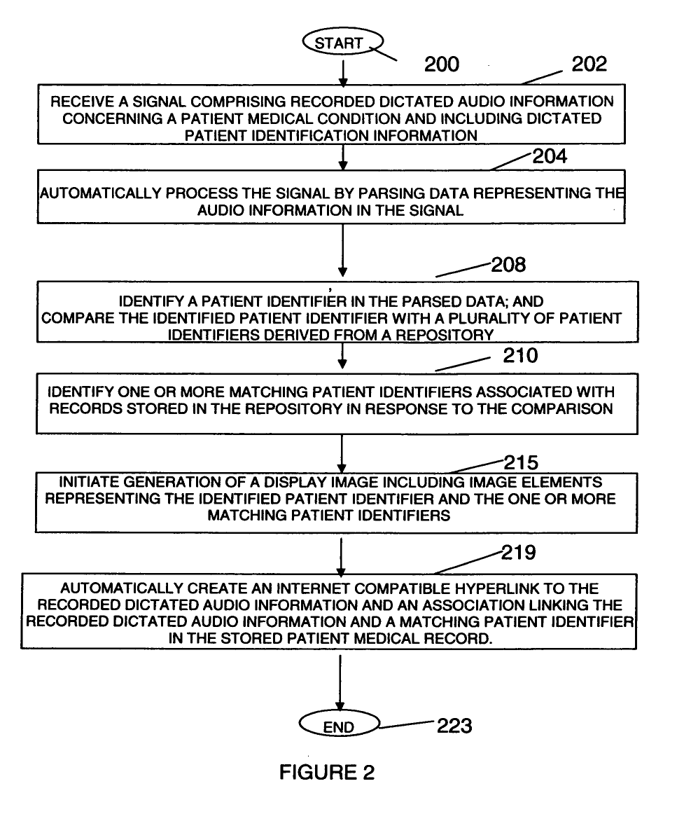

FIG. 2 shows a flowchart of a process employed by the system of FIG. 1 for processing audio information. In step 202, following the start at step 200, application 37 receives a signal comprising recorded dictated audio information concerning a patient medical condition and including dictated patient identification information. Application 37 in step 204 automatically processes the signal by parsing data representing the audio information in the signal. In step 208, application 37 in conjunction with application 43, identifies a patient identifier in the parsed data and compares the identified patient identifier with multiple patient identifiers derived from a repository. Application 43 compares the identified patient identifier with the multiple patient identifiers by using text or character comparison to match at least a portion of the identified patient identifier with at least a portion of one or more of the multiple patient identifiers derived from the repository. A patient identifier comprises one or more of, a patient name and a patient identification code. Application 43 in step 210 identifies one or more matching patient identifiers associated with records stored in the repository in response to the comparison. The records stored in the repository comprise medical records of a multiple different patients and include recorded dictated audio data files concerning patient medical information.

Application 43 in step 215 initiates generation of a display image including image elements representing the identified patient identifier and the matching patient identifiers. The display image includes an image item enabling a user to create an association linking the recorded dictated audio information and a matching patient identifier. The image item enables a user to create an association linking the recorded dictated audio information and a stored patient medical record corresponding to a matching patient identifier. Application 43 in step 219 automatically creates an Internet compatible hyperlink to the recorded dictated audio information and an association linking the recorded dictated audio information and a matching patient identifier of a stored patient medical record in response to user command entered via the displayed image. Application 43 links the patient identifier with the matching patient identifier in response to a comparison of the patient identifier with multiple patient identifiers derived from a repository. Application 43 also creates an Internet compatible hyperlink to a medical image of the patient within the stored patient medical record. A resultant electronic patient medical record comprises stored data including, clinical information of a particular patient, financial information of a particular patient and administrative information of a particular patient. The clinical information includes an Internet compatible hyperlink to recorded dictated audio information and an Internet compatible hyperlink to a medical image of the particular patient. The administrative information includes information concerning address, patient relatives and contact information of the particular patient and also includes, patient identifiers (such as medical record number), age, gender and other demographic parameters. The process of FIG. 2 terminates at step 223.

The system and process presented in FIGS. 1 and 2 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems and process of FIGS. 1 and 2 may be implemented in hardware, software or a combination of both. The system is usable in other environments (e.g., financial, administrative, demographic) not just healthcare related environments wherever it is necessary to process audio information and provide a linkage between audio information and records enabling ready access to audio information associated with a particular record.

1. A system for managing recorded audio information concerning a patient medical condition, comprising:
an interface for receiving a signal comprising recorded dictated audio information concerning a patient medical condition and including dictated patient identification information;
a voice recognition processor for automatically processing said signal by parsing data representing said audio information in said signal and identifying a patient identifier in said parsed data; and
a database manager for comparing said identified patient identifier with a plurality of patient identifiers derived from a repository to identify one or more matching patient identifiers associated with records stored in said repository.

2. A system according to claim 1, including
a display generator for initiating generation of a display image including image elements representing said identified patient identifier and said one or more matching patient identifiers.

3. A system according to claim 2, wherein
said display image includes an image item enabling a user to create an association linking said recorded dictated audio information and a matching patient identifier.

4. A system according to claim 3, wherein
said records stored in said repository comprise medical records of a plurality of different patients and
said image item enables a user to create an association linking said recorded dictated audio information and a stored patient medical record corresponding to said matching patient identifier.

5. A system according to claim 4, including
a link processor for automatically creating an Internet compatible hyperlink in said stored patient medical record to said recorded dictated audio information in response to said created association.

6. A system according to claim 1, including
a link processor for automatically creating an association linking said recorded dictated audio information and a matching patient identifier.

7. A system according to claim 6, wherein
said records stored in said repository comprise medical records of a plurality of different patients and
said linking processor automatically creates an Internet compatible hyperlink in said stored patient medical record to said recorded dictated audio information in response to said created association.

8. A system according to claim 7, wherein
said stored patient medical record also includes an Internet compatible hyperlink to a medical image of said patient.

9. A system according to claim 1, wherein
said records stored in said repository comprise recorded dictated audio data files concerning patient medical information.

10. A system according to claim 1, wherein
a patient identifier comprises at least one of, (a) a patient name and (b) a patient identification code.

11. A system according to claim 1, wherein
said database manager compares said identified patient identifier with said plurality of patient identifiers by using text/character comparison to match at least a portion of said identified patient identifier with at least a portion of one or more of said plurality of patient identifiers derived from said repository.

12. A system according to claim 1, wherein
said interface automatically downloads said recorded dictated audio information from a voice recorder and stores said recorded dictated audio information in a .wav compatible file format.

13. A system according to claim 12, wherein
said recorded dictated audio information in .WAV compatible file format is stored within a patient specific location in said repository and is accessible in response to user selection of a hyperlink in a retrieved patient medical record.

14. A method for managing recorded audio information concerning a patient medical condition, comprising the activities of:
receiving a signal comprising recorded dictated audio information concerning a patient medical condition and including dictated patient identification information;
automatically processing said signal by parsing data representing said audio information in said signal;
identifying a patient identifier in said parsed data; and
comparing said identified patient identifier with a plurality of patient identifiers derived from a repository; and
identifying one or more matching patient identifiers associated with records stored in said repository in response to said comparison.

15. An electronic patient medical record, comprising:
stored data including,
clinical information of a particular patient,
financial information of a particular patient,
administrative information of a particular patient and wherein said clinical information includes an Internet compatible hyperlink to recorded dictated audio information.

16. The electronic patient medical record of claim 15, wherein
said stored patient medical record also includes an Internet compatible hyperlink to a medical image of said patient.

17. The electronic patient medical record of claim 15, wherein
said Internet compatible hyperlink to said recorded dictated audio information is automatically created in response to linking a patient identifier derived from said recorded dictated audio information with a patient identifier of a stored patient medical record.

18. The electronic patient medical record of claim 17, wherein
said linking of said patient identifier derived from said recorded dictated audio information with said patient identifier of said stored patient medical record is performed in response to comparing said patient identifier derived from said recorded dictated audio information with a plurality of patient identifiers derived from a repository.

19. The electronic patient medical record of claim 15, wherein
said administrative information includes information concerning address, patient relatives and contact information of said particular patient.
